(19) United States
(12) Patent Application Publication
(10) Pub. No.: US 2010/0262357 A1
(43) Pub. Date: Oct. 14, 2010

(54) ANTI IDLING CONTROL SYSTEM AND METHOD OF CONTROLLED ENGINE SHUTDOWN

(76) Inventors: A. Richard Dupuis, Pickering (CA); Sean W. Callahan, St. John's (CA)

Correspondence Address: GREER, BURNS & CRAIN, 300 S WACKER DR, 25TH FLOOR, CHICAGO, IL, 60606, US

(21) Appl. No.: 12/708,981

(22) Filed: Feb. 19, 2010

(30) Foreign Application Priority Data
Apr. 12, 2009 (CA) 2.688.000

(51) Int. Cl. F02D 45/00; B60Q 1/00

(52) U.S. Cl. 701/112; 123/339.17; 340/439

(57) ABSTRACT

A system is provided for automatically shutting off a running internal combustion engine after a predetermined length of idle time has occurred, for installation into a vehicle having electronic diagnostic and control computers incorporated to the vehicle. A first switching apparatus is provided, having open and closed modes for disabling and enabling the ignition system respectively. A second switching apparatus is provided, having open and closed modes for disabling and enabling the ignition system. A data collection device receives data from the connected vehicle diagnostic port including: battery level, engine RPM, vehicle speed, door ajar status, ambient temperature, handbrake status and brake pedal position. A computer is programmed to determine if the data from the diagnostic port set up the prerequisites to safe shutdown engine running operation, and to signal the first and second switching apparatuses to shut down the vehicle engine.

### BACKGROUND

The present invention relates to an engine control system and more particularly to a method of shutting off an internal combustion engine after a timed period of unmonitored engine idle. The system is referred to as the Anti Idling Control System and includes said Anti Idling Control Module (AITCM).

Internal combustion engines are utilized in a variety of applications including passenger vehicles, commercial vehicles, and marine vessels, on road and off road farm equipment, stationary generators amongst others. Impartial to the fuel type used, idling persists as a major contributor of green house gas emissions due to negligence. Mostly associated with the temperature variations of seasons associated with northern and southern hemisphere countries and with respect to winter and summer temperatures witnesses errant idling and wasteful energy use.

Most countries located to these hemispheres have existing policies and laws enacted as to prevent wasteful idling however is rarely enforced as a result of policing. A great percentage of vehicle operators pay little attention if any to the wasteful nature of engine idle and related green has gas. There is more of a concern to either heat up or cool off the occupant cab.

World estimations place idling, defined as engine working while not under load specifically for the purpose of temperature convenience for occupancy cab, the amount of spent fuel is in the order of 2% to 5.5% total yearly fuel usage dependant on climatic location. In Canada the average yearly travelled distance for heavy commercial vehicle used in freight transport is in the order of 100,000 Km/yr. with an average fuel consumption of 32 L/100 Km, (data furnished and published by Transport Canada 2005).

Heavy commercial freight companies and fleet operators are looking to reduce energy costs where ever possible, the addition of the present invention yields the desired results by reducing excessive engine idle. Total elimination of unloaded engine idle is not possible as there are circumstances to contend with including temperature extremes and traffic conditions commonly referred to as stop and go.

The present invention by means of connection to the onboard vehicle diagnostics port collects operation specific data allowing for systematic engine shutdown, safe guards and interlocks have been instilled within the present invention preventing false engine shutdown, these include but are not limited to vehicle ignition status, hand brake position, brake pedal position, transmission gear, clutch position (if present), throttle position, engine speed, vehicular road speed and cab temperature. The starting and re-starting of the engine is never prevented, there are no lockout periods nor system delays imposed, a required rotation of the ignition key from run (position when engine was shutdown) to off through to start produces the desired effect.

### SUMMARY

In accordance with the prime aspect of the invention the system has the capabilities of a systematic engine shutdown after a predetermined length of time. The time length is in compliance with local provincial or state regulations either being 3 minutes or 5 minutes dependant on locale.

The present invention works in conjunction with the onboard vehicle diagnostic signals obtained from the diagnostics port, noting vehicles manufactured prior to 1996 model year are considered outside the compatible range of vehicles as these vehicles have limited localised electronic control systems. The present invention includes a series of electromechanical relay switches, a control module, associated wiring harness and a dashboard mounted display unit.

A temperature sensor integral to the control module is dedicated to measuring occupancy cab temperature of which temperature data is used to determine the safe guard temperature limits the control module is permitted to perform systematic engine shutdown. Temperature limits are imposed for both low and high ambient temperatures, the upper limit is +30° C. and the lower limit is −20° C. as default values.

In accordance with another aspect of the invention, two peripheral control signals are provided and used to interface through to supplemental heating and air conditioning (HVAC) systems. These signals are engaged at the extreme weather points by providing a low signal output through to the respective system. The output signal(s) remains active for the period required to bring the cab temperature reaches the safe temperature zone.

In accordance with another aspect of the of the invention, the control module signals for controlling the supplemental heater and cooling system are active only while the control module has effected a systematic engine shutdown sequence. At all other times the control module releases control to local temperature control systems.

Safe guards are instilled to the base functionality of the control module preventing the module from false engine shutdown. Specific vehicle data derived from the diagnostic port are used in the operation of the control module. Data derived from the vehicle diagnostic port is obtained via command(s) from the control module of the present invention.

The control module under normal conditions operates from the “Ignition On” position and verifies engine running via collected data from the diagnostic port. In series with the ignition “Run” signal wire is an electromechanical relay switch un-energized. A second electromechanical relay switch un-energized is provided to disconnect the signal from the vehicle ECM accordingly preventing battery rundown in unattended running vehicles once the control module carries out an engine shutdown sequence.

In accordance with another aspect of the invention, a method of displaying status information is provided through to the observer. The display consists of multi-coloured light emitting diodes operating in specific lighting patterns. The display is intended to be mounted in easy access view of the observer proving a simple means of current system status including systematic engine shutdown indicator.

Objects features and advantages of the present invention include an improved fuel usage; reduction in green house gas emissions prolongs engine life, reduces maintenance and provides a feedback display indicating the current status of the system.

### BRIEF DESCRIPTION OF THE DRAWINGS

The present preferred of the embodiments of the invention are disclosed in the following descriptions and in the accompanied drawings wherein:

FIG. 1 is a block diagram of the Anti Idling Control System of the present invention;

FIG. 2 is a flow chart illustrating the operation of the Anti Idling Control System module;

FIG. 3 is a logic schematic of the Anti Idling Control System module;

FIG. 4 is a firmware flow chart illustrating the operation of the Anti Idling Control System module;

FIGS. 5a and 5b are three dimensional (3D) renderings of the Anti Idling Control System in pictorial view.

### DETAILED DESCRIPTION

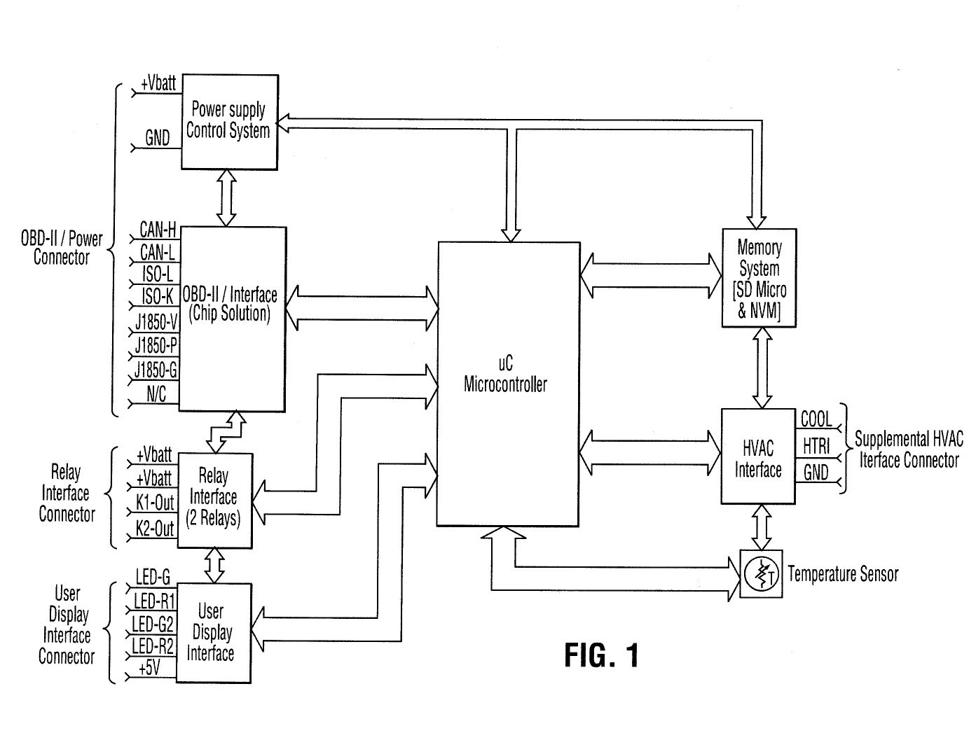

Referring to FIG. 1, an Anti Idling Control System of the present invention automatically stops an internal combustion engine when at idle and after a period of prolonged engine idling provided all sensory signals are positive preventing wasteful use of energy and a cause of pollution. The system is capable of being affixed to domestic passenger vehicles, heavy commercial vehicles including off road equipment and stationary engine generator systems. Through a series of wired vehicle connections signals are derived to allow proper operation of the anti idling control system.

The Anti Idling Control System module contains an automotive grade primary connector, as illustrated to FIG. 1, connections are provided for diagnostic interface, a dual electromechanical relay interface, a LED interface and the supplemental HVAC interface. Power is obtained from the vehicle diagnostic port to operate the Anti Idling Control System module. Internal to the module are two memory devices, a local NVM and the second a standard SD Micro memory module. A temperature sensor is provided as to monitor cabin temperature. At the core of the unit is a 16 bit microcontroller in conjunction to the protocol microcontroller.

The Anti Idling Control System will automatically shutdown the engine by means of the electromechanical relay interface inserted to the ignition wire connecting to the starter circuit system and ECM signal wire of the vehicle provided the ambient temperature is within the safeguard default limits of +30° C. and a lower limit is of 20° C. Should the temperature be outside the safeguard range the anti idling control system shall permit the engine to run in the idle mode until such time the temperature is within the safeguard limits. Control of the external supplemental heater and cooler is provided at the fourteen pin portion of the primary module connector.

The Anti Idling Control System incorporates an automatic protocol selector supporting up to ten specific protocols. The supported protocols are SAE J1850 PWM, SAE J1850 VPW, ISO 9141-2, ISO 14230-4 both fast and 5 baud initialize, ISO 15765-4 CAN (11 bit, 500 Kb), ISO 15765-4 CAN (29 bit, 500 Kb), ISO 15765-4 CAN (11 bit, 250 Kb), ISO 15765-4 CAN (29 bit, 250 Kb) and SAE J1939 CAN (29 bit, 250 Kb). The 10 pin portion of the connector is dedicated to vehicle diagnostics port requirements.

The Anti Idling Control System once powered after installation will automatically select the appropriate protocol and store the selection to local memory as to eliminate the selection process at every ignition key cycle. The process of auto selection is repeated only when total power has been removed from the module as similar to a hardware reset.

The Anti Idling Control System supports a display interface unit consisting of two multi coloured light emitting diodes (LEDs) providing a system status and operation through a series of colour combinations and flash rates, with both LEDs visible as green being “STATUS and OPERATION” indicates system “Normal” operation. The display module is a sub module/secondary module connected through to the designated wires of the 14 pin portion of the primary connector.

The first LED is the system “STATUS LED”, indicates when the module is receiving power and the current status of the internal diagnostics and circuitry. Upon power being provided to the control module of the AITCM the “STATUS LED” shall commence to flash amber at a rate of 2 Hz at a 50% duty factor for the POST (power on self test) cycle. Followed by either a solid red lamp or a solid green solid lamp, the solid red lamp indicates the module is not operating correctly and requires servicing. The solid green lamp indicates the module is working within parameters.

The second LED “OPERATION LED” shall be configured to operate as a multi status indicator, comprising solid and flashing modes of colors being red, green and amber. The solid green lights after the STATUS POST has completed with no problems reported and engine is successfully running, (mode 1).

Mode 2 is engaged when the timer elapses to within 30 seconds of engine shutdown procedure, the OPERATION LED shall commence to flash amber at rate of 2 Hz at a 50% DF proceeding to full red when expired and engine is shutdown.

Mode 3 is engaged to indicate the time has elapsed one period and the operator has re-started the engine. The LED will flash green and red alternately at a rate of 2 Hz. 50% DF and every second cycle skipped. Should the vehicle commence to move this mode will continue to be dominant through to the timer countdown in reverse mode. In total two timer periods will have lapsed. Should the vehicle remaining standing the timer will execute and continue in the same dominant mode with that added ceasing of the red lamp 30 seconds prior to engine shutdown once more and flash the amber lamp as in mode 1.

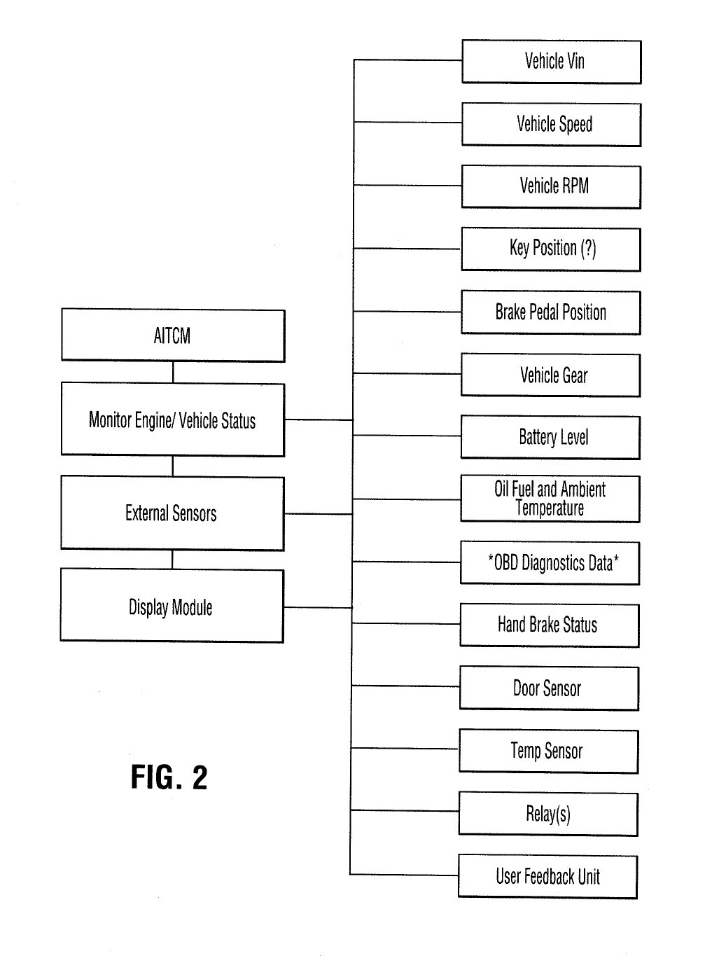

Referring to FIG. 2, an Anti Idling Control System of the present invention is both active and passive in operation and monitors idling of the engine to determine if excessive idling and whether systematic engine shutdown is warranted and possible in the active mode. The Anti Idling Control System monitors engine and vehicle operation exacting vehicle status of being either stationary and/or moving by evaluating signals derived from the vehicle diagnostics data port in the passive mode.

A series of vehicle specific data is requested and collected by the Anti Idling Control System and is used to ascertain current operation and course of action if required to perform a systematic engine shutdown sequence.

The data collected is: Vehicle VIN (Vehicle Identification Number), Vehicle Road Speed, Vehicle Engine RPM, Key Position, Brake Pedal Position, Vehicle Gear, Battery Level, Oil Fuel and (outside) Ambient Temperature, OBD Diagnostics Data, Hand Brake Status, Door Sensor Status, Temp Sensor (module thermal sensor), Relays Status.

Status and Operation are provided through the User Feedback Data as data displayed via the LED display module.

Systematic engine shutdown process relies on a multi-signal consensus process that requires a resolution of all primary sensor signals be positive in order to support a systematic engine shutdown. Automatic system overrides are built in to the system to prevent false positives.

Vehicle VIN (Vehicle Identification Number), is read by the control module at every power on cycle as to verify the Anti Idling Control System is connected to the same vehicle as was initially stored to memory, should the unit be either connected to a different vehicle and/or first time initialized the current memory content data is overwritten with the new and current data.

The primary signals used to the consensus process are: Key Position, Vehicle Road Speed and Vehicle Engine RPM, Vehicle Gear, Brake Pedal Position, Hand Brake Status and Door Sensor. The secondary signals are Battery Level, OBD Diagnostic Data and Temp Sensor. The prime signals are critical in the performance of the systematic engine shutdown assessment process. The secondary signals are providing temperature assessment and OBD Diagnostic Data if any is available in the form of Diagnostic Trouble Codes of which if any will be displayed via the LED Display module.

The electromechanical relays are used in the disconnect functionality of the “Engine Run” signal and the second electromechanical relay is used in the disconnect functionality of the ECM signal wire.

Verification of engine shutdown is provided via the diagnostics data port collected by the Anti Idling Control System. A user is required to rotate the ignition through to the “OFF” position and to re-start the engine proceed with as normal procedure of rotating the key through to crank accordingly. The Anti Idling Control System shall perform a power on self test followed by displaying the status of the system via the LED display. A timer commences within the Anti Idling Control System as the engine signals it is successfully running. The LED display module will display the current status and operation accordingly.

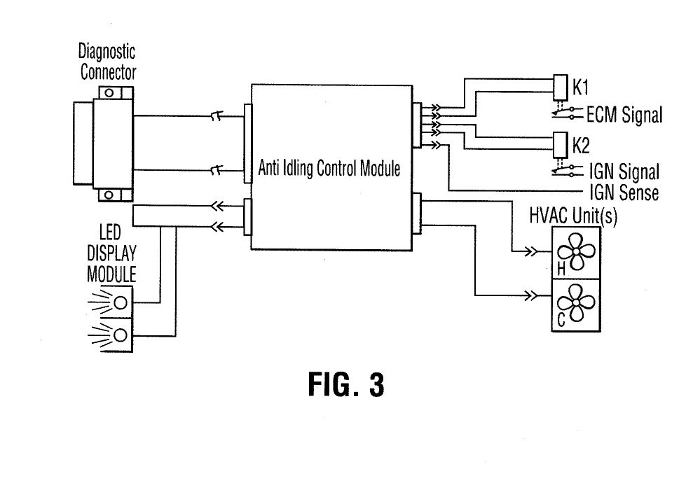

Referring to FIG. 3, the Anti Idling Control System monitors the operation of the engine via connection to the vehicle diagnostic port. The control or the systematic engine shutdown process relies on a variety of data collected from the diagnostic data port and must meet the specific requirements as set out to the operation of the system.

Depicted on FIG. 3 are the diagnostic connector, LED display module, dual electromechanical relays and the output port signals to interface with the vehicle HVAC supplemental systems.

The Anti Idling Control System module remains continuously connected to the vehicle, a bypass diagnostic connector is provided in the harness as not to interfere with vehicle service requirements.

Built into the AITCM is a temperature sensor that is used to monitor cab temperature used directly in the controlling of the HVAC interface signals for both “Heating and Cooling” respectively. The HVAC port is provided as a convenience, and is plugged into already existing supplemental equipment, this feature provides a minimal controlled temperature suitable in keeping with local and federal laws when the vehicle is outfitted with such systems.

K1 and K2 being electromechanical relays are each wired in series with the signal wire from both the ignition wire and ECM ignition wire signals. Both relays are external the Anti Idling Control Module. K1 and K2 are automotive grade Form “A” configuration with the appropriate current contact rating.

The wiring harness assemblies interconnect the Anti Idling Control System through to the vehicle diagnostic port as well to the ignition wire signal directly following the key signal wire signal. The balance of the wiring harness assemblies are connected through to the LED display module and the HVAC interface system. The wiring harness assemblies are fabricated from 18 for power and ground connections and 20 AWG automotive grade wiring for the remainder at the required temperature rating and type.

The connectors used within the Anti Idling Control Module are manufactured by AMP TYCO and based on the automotive grade Multilock series connectors. Inline connectors are of the same type and designation. The main housing assembly is constructed of engineered thermoplastics; this particular plastic includes a 20% glass additive providing a more robust and durable type assembly.

The entire system is designed as a “Plug & Play” installation reducing the amount of time spent performing the physical installation. With the addition of high powered microprocessors at the systems core support expansion capabilities with respect to both firmware and hardware features and provides longevity in useful product life. Additionally the Anti Idling Control System supports field firmware upgradeable memory flashing of the core operating system.

The operation of the system is based on signals derived and received from the vehicle diagnostic data port in conjunction to the hardwired ignition signal. The Anti Idling Control System operates on a basis of issued commands over the diagnostic port bus compatible with the vehicle. Commands signals include but are not limited to, ignition status, engine operation current status including RPM, true road speed and current gear with the balance of signals being brake pedal position, clutch position, throttle position and hand brake status. Ambient temperature is used in conjunction with the internal cab temperature sensor and whether action to request heat or cooling accordingly from the supplemental HVAC equipment is required due to temperature upper and lower limits.

The Anti Idling Control System shall only control the supplemental HVAC system during cycles of systematic engine shutdown provided heating and or cooling are required during this period, at all other times the supplemental HVAC systems operate by their respective local controls.

The Anti Idling Control System decodes signals based on logic levels, a hi logic level signal is considered to be at battery potential +/−1.0 Vdc and a low logic signal considered to be at battery negative (ground potential in negative battery grounded systems as is mostly the standard) in potential +/− 1.0 Vdc. Additionally signals derived from the diagnostic port shall be in the form of the serial data format as dictated by the particular vehicle bus standard of the particular vehicle.

The Anti Idling Control System operates as a passive control system and enters into the systematic engine sequence by monitoring critical signals being engine RPM, vehicle speed, current transmission gear, clutch and brake pedal depression. Should the vehicle not be moving and engine idling for greater than the period of time allotted to idle typically three (3) minutes the shutdown sequence is entered and executed accordingly. Should any of the critical input signals provide a “low” logic level signal the Anti Idling Control System timer shall reset and the shutdown sequence cancelled and shall commence to countdown provided the vehicle is once again stationary.

The Anti Idling Control System includes the feature of built in self system diagnostics easily accessible through a sequence of ignition key toggle positions from “Off” to “On” and with the driver door ajar. Entering the diagnostics mode requires the ignition key be toggled three times from the “Off” through to the “On” position and on the third rotation remain in the “On” position while the driver door is ajar. Display of the internal codes is displayed to the LED display module. The two multi-coloured LEDs are flashed in a sequential pattern as to indicate current values if any. A fault free system shall flash the LEDs simultaneously once each. LED flash rates are based on 2 Hz cycle, 50% duty factor. Status and fault codes are “12” indicates fault with the protocol microprocessor, “14” indicates fault with NVM (Non Volatile Memory), “25” indicates fault with +5 Vdc power supply, “33” indicates fault with SD Micro memory module, “35” indicates fault with onboard temperature sensor, “42” indicates fault with K1 electromechanical relay circuit, “43” indicates fault with K2 electromechanical relay circuit. Turning the ignition key back to “OFF” cancels the diagnostic mode. The Anti Idling Control System diagnostics mode is disabled vehicle engine is running.

Power conservation and battery rundown protection is built in to the Anti Idling Control System. When the vehicle is in the “Off” state the system maintains a low quiescent state of power and will resume full power when the ignition signal is detected and shall remain active for up to 2 minutes thereafter awaiting the starting of the engine, should the engine not be started the system will resume a low power quiescent state.

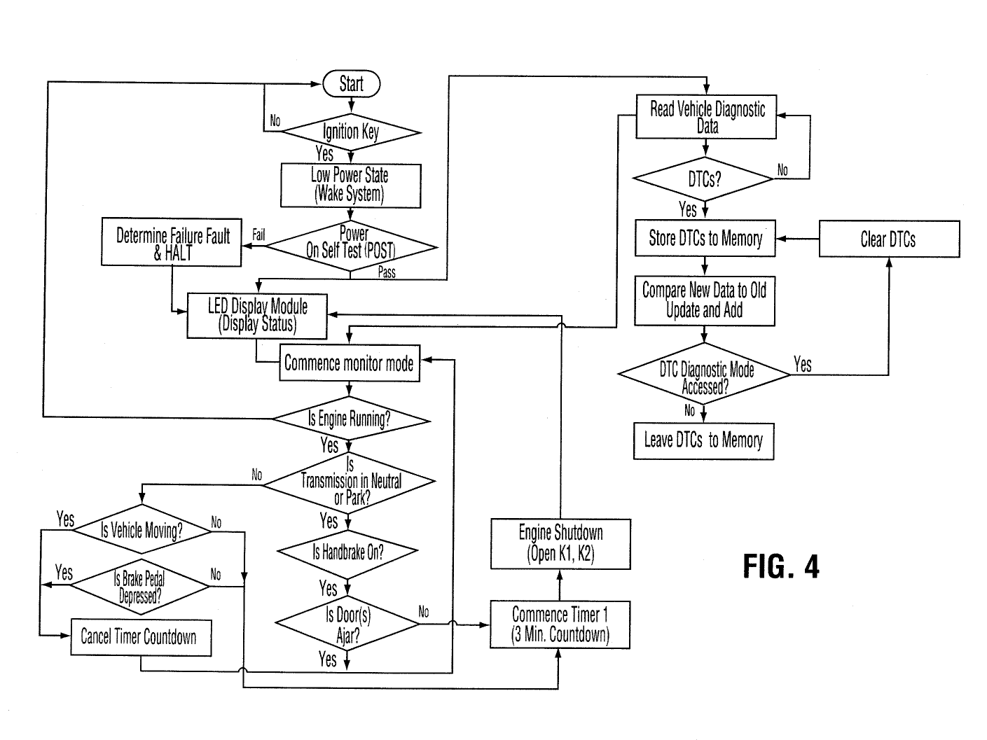

Referring to FIG. 4, an Anti Idling Control System of the present invention depicts the firmware operational flowchart. At the “Start” of the program the ignition key is checked, if there is no key present the system resumes back to “Start” until a change is recognized. Upon verification a key is present and the key has been rotated towards the “ON” position and further to the “Start” engine sequence forces the Anti Idling Control System to wake to the ready state.

The Anti Idling Control System performs and internal “Power On Self Test”, (POST) to establish operation. Should POST fail a determination is carried out to establish the failure and display the notice via the LED display.

Should POST be successful the LED display shall display the all “Normal” indication and the specific type data required by the Anti Idling Control System is read from the vehicle diagnostic data port accordingly. From the diagnostic port data is routed to both the “Monitor Mode” block as well to the “DTCs” (Diagnostic Trouble Codes) block. The “Monitor Mode” commences evaluating the vehicle specific data as illustrated by the depicted decision blocks “Is Engine Running?”, “Is Transmission in Neutral or Park?”, “Is Handbrake On?” and “Is Door(s) Ajar?”

Should the vehicle be in any other gear of than “Neutral and/or Park” the next action is to determine if the vehicle is moving followed by evaluating if “Brake Pedal” is “Depressed”. Upon assessment of the aforementioned a decision is made whether to “Cancel” the running timer or to permit with countdown provided the “Monitor Mode” loop agrees.

Should the two individual branches agree with an engine shutdown then after three minutes of unchanged data the system shall proceed with shutdown of the engine and open circuit the two signal paths connecting the ignition signal to the engine run signal and the ignition signal to the engine control module (ECM).

If any of the monitored items read positive then a reset to countdown timer is initiated thus eliminating the engine shutdown cycle to complete. Safeguards are built into the system, specifically all derived signals must be in consensus in order to successfully initiate an engine shutdown, and secondly, any unattainable signal prevents the entire system from normal operation thus displaying a “Problem” status to the LED display.

The anti Idling Control System has the built in capabilities to monitor the vehicles own diagnostic information. This feature permits for easy access to view what codes are present in the system. Viewing the DTCs is achieved by force entering the Anti Idling Control System in to the vehicle diagnostics mode through a sequence of ignition key rotations while having a door ajar. The LED display is used for the purposes to display stored information.

Clearing of the DTCs from the Anti Idling Control System is automatically achieved upon exiting the mode. Vehicle memory content of the DTCs are not altered and left intact. Dynamic review for DTCs is as well automatic and stored through to local Anti Idling Control System memory for later review if so desired. Repeat DTCs are recorded once only through to the AITCM memory.

If no diagnostics DTCs review by a user have been initiated for extended periods of time then current stored DTCs to local memory of the Anti Idling Control System may be overwritten by the vehicle current status report obtained at every ignition key on cycle. Vehicle DTCs from time to time may be internally overwritten as a result of a flagged problem that internally corrects itself thus the information is collected by the Anti Idling Control System and updated accordingly.

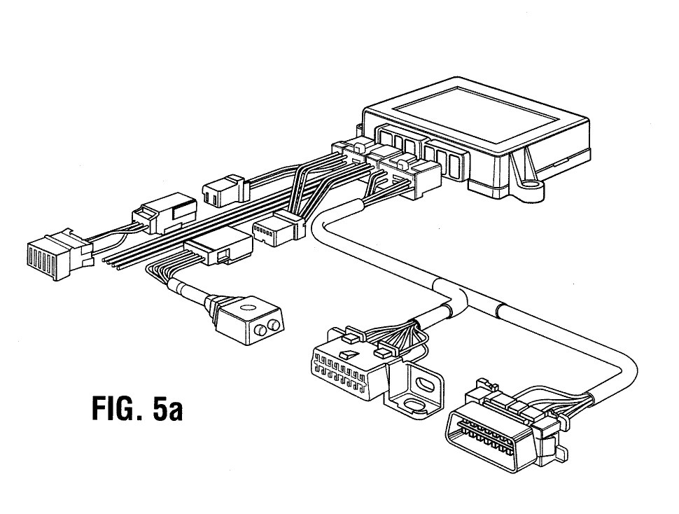

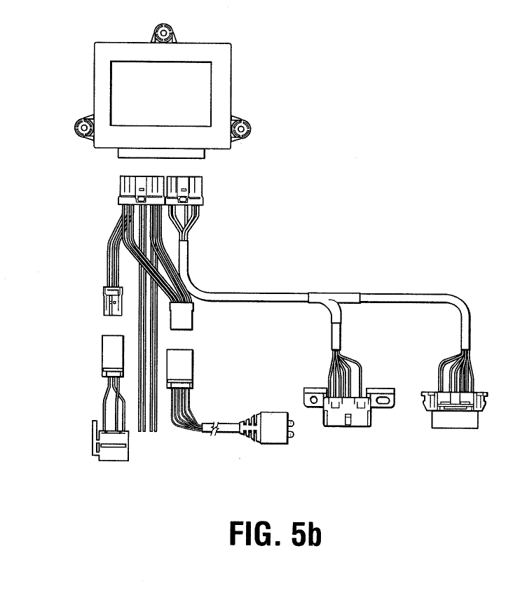

FIGS. 5a and 5b are three dimensional (3D) renderings of the Anti Idling Control System in pictorial view.

Referring to FIG. 5a depicts the various components that make up the physical Anti Idling Control System. Located on the diagnostic port cable assembly are three connectors, one being the module 10 pin followed by two common On Board Diagnostic (OBD) connectors 16 pin of each gender supporting the pass thru requirements of the system.

The display LED module is clearly visible depicting a green and yellow lamp colouring noting this is for purposes of depiction only. The individual depicted wires are for K1, K2 and the Ignition connections respectively followed by the HVAC interface harness assembly depicting a second branch of which is fabricated to a standardized length as required, the depicted is for purposes of depiction only.

As illustrated a 14 pin module connector supports the HVAC interface, K1 signal wire, K2 signal wire, Ignition signal wire and LED Display harness assembly and display module.

Referring to FIG. 5b depicts the top view of the Anti Idling Control System assembly with clear view of the harness assemblies and various harness branches. The module housing depicts a three mounting point assembly of which suffices for application of the assembly to uneven surfaces.

The housing is moulded from engineered thermo plastic consisting of glass reinforced polycarbonate nylon mixture yielding a respectable shore hardness and resilient housing assembly. The wire harness assemblies are fabricated from automotive grade wire type TEW at minimum 105° C. Connectors are AMP TYCO automotive type as per requirement.

While a particular embodiment of the present anti idling control system and method of controlled engine shutdown has been described herein, it will be appreciated by those skilled in the art that changes and modifications may be made thereto without departing from the invention in its broader aspects and as set forth in the following claims.

1. A system for automatically shutting off a running internal combustion engine after a predetermined length of idle time has occurred, for installation into a vehicle having electronic diagnostic and control computers incorporated to the vehicle comprising:
a. first switching apparatus for disconnection along an ignition signal wire between the ignition system and the engine running circuits, the first switching apparatus having an open and closed modes for disabling and enabling the ignition system respectively;
b. a second switching apparatus for disconnection along an ignition signal wire between the ignition signal wire and an ignition signal input to an ECM (engine control module), the second switching apparatus having an open and closed modes for disabling and enabling the ignition system respectively;
c. a data collection device for receiving data from a connected vehicle diagnostic port consisting of: battery level, engine RPM, vehicle speed, door ajar status, ambient temperature, handbrake status and brake pedal position;
d. a computer programmed to determine if said data from said vehicle diagnostic port set up the prerequisites to safe shutdown engine running operation, and to signal the first and second switching apparatuses to shut down the vehicle engine.

2. The system for automatically stopping a running engine set forth in claim 1 further comprising visual indication to the driver via dual multi color LED display being Status LED and Operation LED indicating via specific flash rate and color pattern of the current operation.

3. The system of claim 1, further comprising a computer being programmed to automatically evaluating said vehicle data to establish ambient temperature and vehicle cab temperature are outside a predetermined temperature range and override engine shutdown procedure to bring the cab temperature back to within predetermined temperature limit range after which shutdown when cab temperature is within predetermined temperature limit range, said system comprising visual indication via LED display of the functional operation.

4. The system of claim 2 further being provided with programming to collecting vehicle diagnostic Trouble Codes and make same available through visual indication via said LED display module by:
a. a combination of received door ajar data from said vehicle diagnostic port and a series of ignition key rotations from off to on and leaving key in position of on to invoke the operation of viewing said vehicle diagnostic trouble codes in a series of flash sequences via the LED display; whereby
b. exiting the diagnostic mode by rotation of ignition key back to off position.
c. vehicle engine is not permitted to operate while vehicle diagnostic mode is operational.

5. The system of claim 1, further comprising external heating ventilation and cooling (HVAC) control when supplemental systems are installed:
a. by evaluation of the ambient temperature from data obtained from said vehicle diagnostic data port and cab temperature assessment with actuation of supplemental HVAC automatic;
b. when supplemental HVAC is present automatic engine shutdown is enabled to operate without provision of claim 3 (a) under all temperature conditions;
c. control of the HVAC systems being limited to bring the cab temperature back to within predetermined temperature limit range after which shutdown and restarted if necessary to maintain predetermined temperature limit range.

6. The system of claim 1, wherein said witching apparatus comprises an electromechanical relay device or equivalent solid state switch device.

7. The system of claim 1, wherein connection to said vehicle diagnostic port is required for full functional operation.

8. The system of claim 1, wherein said system receives ignition signal and data signals from said vehicle.

9. The system of claim 1, comprising at least one LED display module for displaying “Status” and “Operation” information to the driver through a series of flash patterns and LED color.

10. A method of monitoring a vehicle engine and shutting of the vehicle engine to prevent excessive idling employing the system of claim 1.
